(19) United States
(12) Patent Application Publication
(10) Pub. No.: US 2023/0368278 A1
(43) Pub. Date: Nov. 16, 2023

(54) MODULAR PHOTO KIOSK SYSTEM

(71) Applicant: Kodak Alaris Inc., Rochester, NY (US)

(72) Inventors: Scott C. Robinson, Rochester, NY (US); Joseph A. Manico, Rochester, NY (US)

(73) Assignee: Kodak Alaris Inc., Rochester, NY (US)

(21) Appl. No.: 18/198,032

(22) Filed: May 16, 2023

Related U.S. Application Data
(60) Provisional application No. 63/342,514, filed on May 16, 2022.

(51) Int. Cl. G06Q 30/0601; G06Q 20/20; G06Q 10/20; H04N 1/34; H04N 1/00

(52) U.S. Cl. CPC G06Q 30/0641; G06Q 30/0621; G06Q 20/202; G06Q 20/203; G06Q 20/204; G06Q 10/20; H04N 1/34; H04N 1/00188; H04N 1/00167

(57) ABSTRACT

Disclosed herein are embodiments of a modular photo kiosk system that produces prints that include printed templates, guides, and instructions for use with matching designated user provided photo. The systems are configurable so that they can be easily combined to adapt the kiosk system to meet the productivity, capacity, product range, inventory control, and physical conditions of a selected retail environment. The kiosk can include remote access for customers and kiosk owners to place remote orders and manage kiosk inventory and further include a secured product display area featuring photo products for sale. A further aspect of the technology described herein comprises a software application for use by clerks for monitoring, maintaining, and operating the photo kiosk system.

### CROSS-REFERENCE TO RELATED APPLICATIONS

This application is a non-provisional of and claims priority to U.S. provisional application number 63/342,514, filed on May 16, 2022. All publications, patents, patent applications, databases and other references cited in this application, all related applications referenced herein, and all references cited therein, are incorporated by reference in their entirety as if restated here in full and as if each individual publication, patent, patent application, database or other reference were specifically and individually indicated to be incorporated by reference.

### BACKGROUND OF THE INVENTION

The present disclosure relates to modular photo kiosk systems that are capable of various configurations. Embodiments of such systems offer varying levels of autonomy and security configurations for use in different retail service environments and feature applications with functionality and controls for photo kiosk management and maintenance.

Traditional photo kiosk systems have used a rigid framework for the design of the kiosk itself, which can be limiting in multiple respects. First, the traditional photo kiosk system can be of fixed dimensions. This can constrain the number and types of products that the kiosk can hold and limit the spaces the kiosk can physically occupy. The physical setup of the interior of the kiosk can further restrict the product availability and flexibility for different types and availability of products depending on demand at the kiosk. Finally, traditional kiosk systems require a fixed amount of management and intervention by retail employees. Recent retail trends have resulted in the desire to lower retail costs resulting in fewer employees. The remaining employees are often lower employee skill due to higher turnover rates which are not conducive to high intervention kiosks requiring detailed management and repair.

Traditional photo kiosks also often require in-store interaction to select and create the photo product based on a consumer's uploaded images. This can cause additional complexity and issues due to the amount of time it can take to select the images, photo products, and additional personalization components at the kiosk. This can be further complicated where there are time restrictions for ordering the products, additional customers queuing at the kiosk, privacy concerns in combination with additional customers in queue, and parents managing children while trying to work through the product selection process. Additionally, limited and fixed kiosk inventories can result in the unavailability of certain products resulting in additional pressure and complications when selecting alternative options. This can result in the creation of incorrect orders or products that do not meet customer expectations.

As traditional kiosk systems require in-person interaction, they often are limited in where photo input can be received. Remote orders may not be possible for kiosks which do not have proper connections to receive such orders. Photos printed from remote orders may also be inaccessible or difficult to access depending on the storage location. This is because these remote orders need to be kept accessible for pickup while still maintaining privacy of the products. As such, there is a need in the art for a photo kiosk with additional flexibility for use in different scenarios.

### SUMMARY OF THE INVENTION

Described herein are embodiments of modular photo kiosk systems for processing photo product orders, including remote photo product orders. Embodiments can be modular to improve flexibility, adaptability, and customization. The modules can be configured for interchangeable incorporation and removal from a kiosk. When incorporated into the kiosk, the modules may be communicable with and connected to the kiosk such that the kiosk can recognize different mechanical, electrical, software, and GUI modules and adapt according to the connected modules. The modules can self-identify electronically, can be configured using a manifest, or can be configured through human and/or machine-readable codes such as QR codes.

The modular system can further be configured to use no or simple tools to assemble the kiosk. Access to the connection points between modules can be controlled to prevent tampering. Mechanical and electrical connections can be provided internal to the modules, which may be accessed through panels and doors. This can allow for the setup of individually unique kiosks with limited visible connections and cords between the modules.

The kiosk can further include inventory monitoring and control systems to prevent theft of unpurchased products and inventory control. These can include computer vision, mechanical, or electrical components to monitor products on display. Detection of theft can result in alarms or recorded voice warnings. Access to products can also be controlled such that access is only permitted after payment or identification verification.

The kiosk can be designed to require minimal employee intervention such that it is suitable for use with employees with little-to-no technical training. Employees with additional training or skill level may have different and greater levels of access to the kiosk. The kiosk may also include self-service print redemption, integrated payment transactions, and self-service purchase and assembly to further minimize employee interaction.

The kiosk can manage both local and remote ordering with touchless access. The kiosk can receive orders from smart phones or other remote devices. This can allow for image selection, image editing, product selection, and transaction validation both on-site at the kiosk or through the remote device. When performed through a remote device, the kiosk can allow for “touchless” operation to obtain photo products without physical contact with the touch screen or payment device of the kiosk when provided. The kiosk can include credit card, near-field communication (“NFC”) payment, and mobile phone payment acceptance devices which can allow access to the purchased products when approved. The products can be stored in individual locked compartments which can become accessible after payment.

Described herein are embodiments of a photo clerk assistant tool for maintaining a photo kiosk. The tool can be deployed as a software application for monitoring, maintaining, and operating one or more photo kiosks. The tool can be configured with a proximity function. This can be used to ensure the kiosk can only be accessed when the tool is near the kiosk and to record the clerk performing the operations. The tool can further include error condition reporting. This can identify maintenance issues associated with the kiosk and assist clerks with performing maintenance operations. Errors and failures can further be configured to be automatically documented and recorded.

The tool may use augmented reality to assist in training, troubleshooting, and repair of the kiosk. The tool may also a chat box to contact external support during troubleshooting and repair of the kiosk. The chat box can be further used to schedule outside repair services, order additional inventory, and check the status of specialty orders being shipped to the retail location. The tool can be further be configured with a quality check app. This can be used to record test prints to check and record proper maintenance of the kiosk. A clerk application validation function can be used to record which clerk is accessing the kiosk for maintenance or customer support. This can further provide access to various kiosk maintenance modes.

The tool can further include clerk assistance for operating the kiosk. This can include shutdown procedure instructions for kiosks that do not operate in 24-hour retail environments. The tool can further include upsell reminders and tracking. This can be used to encourage additional purchases when assisting a customer with the kiosk. For remote orders that are not picked up, the tool can be configured to provide instructions for managing the unretrieved orders. Additionally, the tool can be configured to provide an interactive floor plan map of the retail space. This can be used for quickly finding kiosks requiring maintenance and to support production of specialized orders. The tool can be configured with a clerk check-in feature to ensure the kiosk is properly staffed.

The tool can further include the ability to coordinate with personal shoppers. This can allow for the remote order placement and pickup through personal shoppers as supported by the retail location.

### BRIEF DESCRIPTION OF THE DRAWINGS

The present technology will be better understood upon reading the following detailed description of non-limiting embodiments and examining the accompanying drawings, which are summarized as follows.

FIG. 1A depicts a modular photo kiosk and connection system according to an embodiment of the present technology.

FIG. 1B depicts an alternate embodiment of a modular photo kiosk.

FIG. 2A depicts a modular photo kiosk with product display and management system according to an embodiment of the present technology.

FIG. 2B depicts a modular photo kiosk embodiment with product display and management system with instructions for retrieving photo merchandise.

FIG. 3A depicts a sliding door with electronic solenoid lock for inventory control according to an embodiment of the present technology.

FIG. 3B depicts an embodiment of doors comprising a camera on the door sweep prior to assembly according to an alternative embodiment of the present technology.

FIG. 3C depicts an embodiment of an assembled product display area.

FIG. 4A depicts an embodiment of an unlocked and closed product management door.

FIG. 4B depicts an embodiment of an unlocked product management door with the left side open.

FIG. 4C depicts an embodiment of an unlocked product management door with the right side open.

FIG. 4D is an embodiment of an unlocked and closed product management door.

FIG. 5 depicts a modular photo kiosk with electronic camera for inventory management and control according to an embodiment of the present technology.

FIGS. 6A-6B depict a connector array drawer according to an embodiment of the present technology.

FIG. 7 depicts an embodiment of a kiosk with a personal shopper module.

FIG. 8 depicts a method using the kiosk through a personal shopper and remote order.

### DETAILED DESCRIPTION

Aspects, features, and advantages of the present technology will be further appreciated when considered with reference to the following description of embodiments and accompanying drawings. In describing embodiments of the technology, including particular embodiments illustrated in the drawings, specific terminology will be used for the sake of clarity. The embodiments of the present technology, however, are not intended to be limited to the specific terms used, and it is to be understood that each specific term can include equivalents that operate in a similar manner to accomplish a similar purpose. To the extent features of the present technology are depicted in the drawings in different embodiments, it should be understood that features from different embodiments can be combined to achieve the full functionality described herein unless expressly disclaimed otherwise.

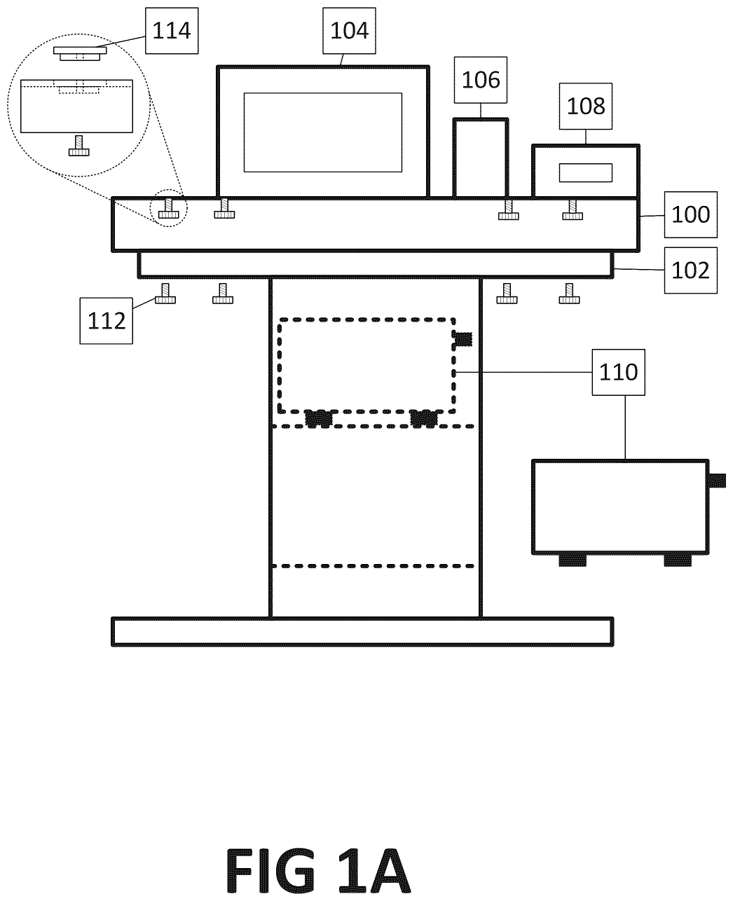

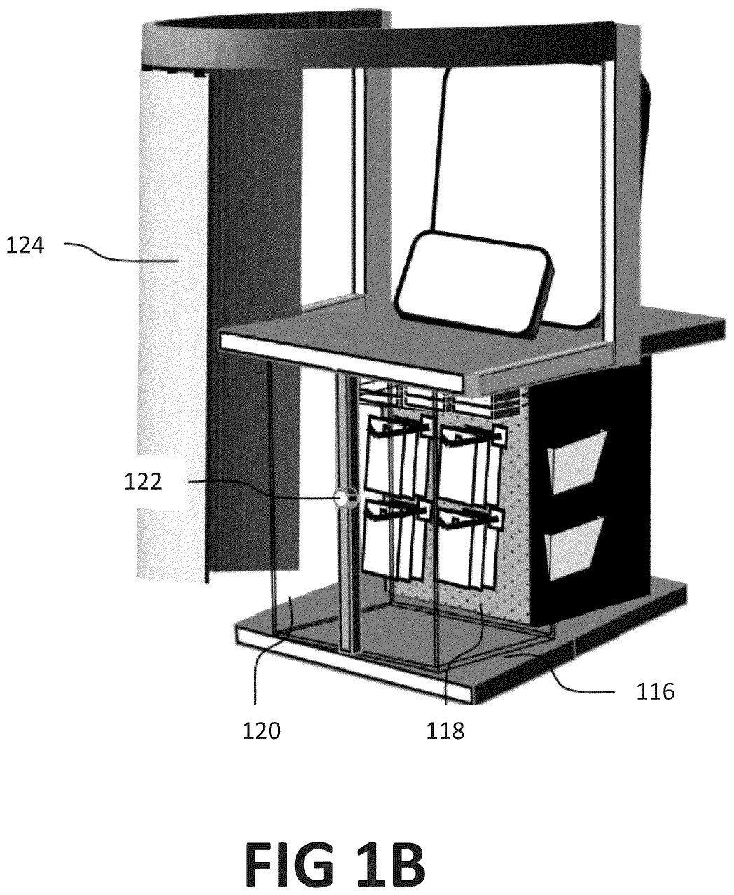

FIG. 1A depicts a modular photo kiosk according to an embodiment of the present technology. The kiosk in this embodiment can include a finished mounting surface 100 and hidden mounting board 102 such that the finished mounting surface 100 may be mounted on the hidden mounting board 102. The finished mounting surface 100 may serve as a mounting location for various modules of the kiosk. The kiosk may further include a processor and a communication device. The processor can control the kiosk and interactions with customers. The communication device can allow the kiosk to communicate locally and remotely with different other systems as appropriate for the kiosk. The communication device can communicate by a wired connection, wireless cellular, or Wi-Fi modem.

A touch screen display 104 may be mounted on the finished mounting surface 100 in an embodiment. The touch screen display 104 may be of any appropriate size and dimension for customer interaction with the kiosk. In some embodiments, the touch screen display 104 may not be included as a part of the kiosk. In these embodiments, the customer may interact with the kiosk through a smart phone display or any other appropriate method.

The photo kiosk can provide a phone-centric workflow regardless of whether the touch screen display 104 is included in the kiosk. Accordingly, certain embodiments of the photo kiosk can allow for image selection, editing, product selection, ordering, and payment to be performed through a user device, whereas other embodiments facilitate these actions through the touch screen display 104, or allow for both use of a user's mobile device and the touch screen display 104. Operations via a user's mobile device can be done remotely, which can reduce queue lengths at the kiosk. Remote ordering operations in certain embodiments enable a user to select a particularized location for a specific kiosk, or alternatively select a radius (either measured in distance or travel time) to cover all kiosks within a certain area. Customers using remote order can also select a type of photo product to search for kiosks. According to this search methodology, users can identify and locate kiosks that are appropriately configured to produce and fulfill the user's product request. Phone-centric workflow of particular embodiments can reduce the size and space of the kiosk, which may in turn provide additional space for print and product options. Further, this can reduce the number of contact points when interacting with the kiosk reducing surface born bacterial or viral spread.

A payment module 106 can be mounted on the finished mounting surface 100 in some embodiments. The payment module 106 can include a credit card reader, an NFC payment reader, and/or currency acceptors. The payment module 106 can have its own display and UI or work interactively with the touch screen display 104 when provided. In other embodiments, a payment module 106 may not be included in the kiosk. In these embodiments, payment can be completed through the use of a mobile device or any other appropriate method.

A digital converter 108 can also be mounted on the finished mounting surface 100 in some embodiments. The digital converter 108 can be a self-contained digital cutter for hard copy photo prints and photo products. The digital converter 108 may comprise a digital scanner or reader, and alignment mechanism, and a cutting mechanism. Digital converter 108 can be configured to read a code, via the digital scanner or reader, associated with a specific product to determine alignment and cut pattern. Prints which can be produced at the kiosk can be inserted into the digital converter 108 which are cut and ejected to be integrated into the photo product. The digital converter 108 can be integrated into the kiosk in some embodiments as an “insert here” slot. The digital converter 108 also can be integrated with the touch screen display 104 to provide instructions for a user on how to proceed. In other embodiments, the kiosk may not include a digital converter 108.

The photo kiosk may include one or more printers 110 in some embodiments. The printers 110 can be configured for different printing requirements, including speed of printing, print capacity, photo size, and media types, including metallic, adhesive, or premium media. The printer 110 can be in communication with the processor to monitor the amount of print media within the printer. When the print media becomes depleted below a threshold, the processor can further be configured to alert an employee to refill the print media or warn a customer that the kiosk may have insufficient media for a current job. The processor may further be configured to predict when print media will need to be refilled based on consumption rates at the kiosk.

The photo kiosk can be attached using screws 112 or any other appropriate fastener. The screws 112 can be such that the kiosk can be assembled with simple hand tools such that specialty tools may not be required. Blank mounting surface plugs 114 may be used to hide the screws 112 used to assemble the kiosk. The blank mounting surface plugs 114 may also include a locking mechanism to prevent unwanted disassembly of the kiosk.

FIG. 1B depicts an alternate embodiment of a modular photo kiosk. According to this embodiment, the photo kiosk can include a product display area 116. The product display area 116 can include a product display module 118 for supporting and displaying products. The product display module 118 may comprise physical components to present hard copy photo products (for example, a peg board with hooks to suspend products being displayed). Alternatively, the product display module 118 can include mechanical or electrical turn and drop mechanisms. These mechanisms can secure photo products until a command is sent by the processor to dispense the product. This can result in additional security for high value products within the product display area 116. Alternatively, the product display area 116 can use shelves or bins for presenting products for purchase.

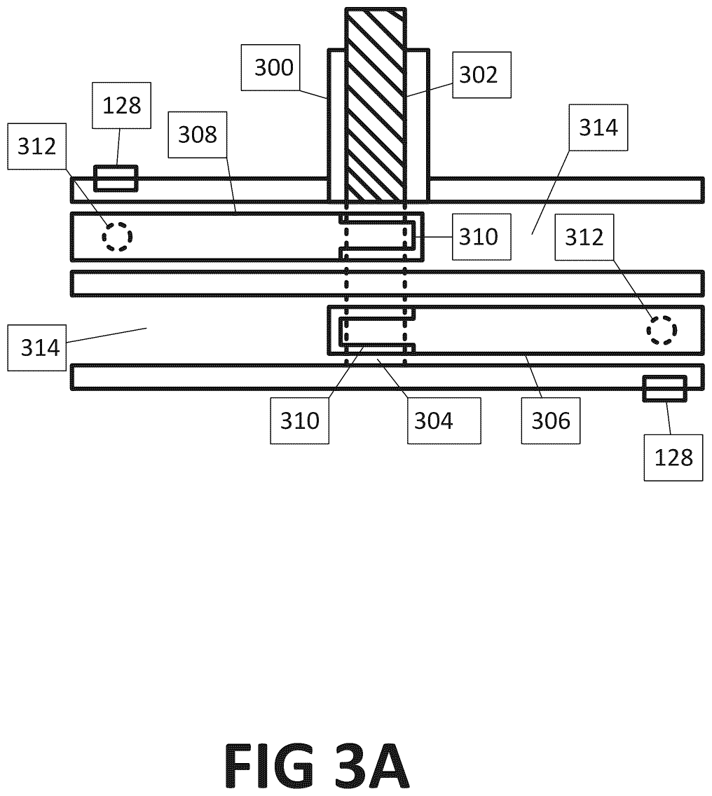

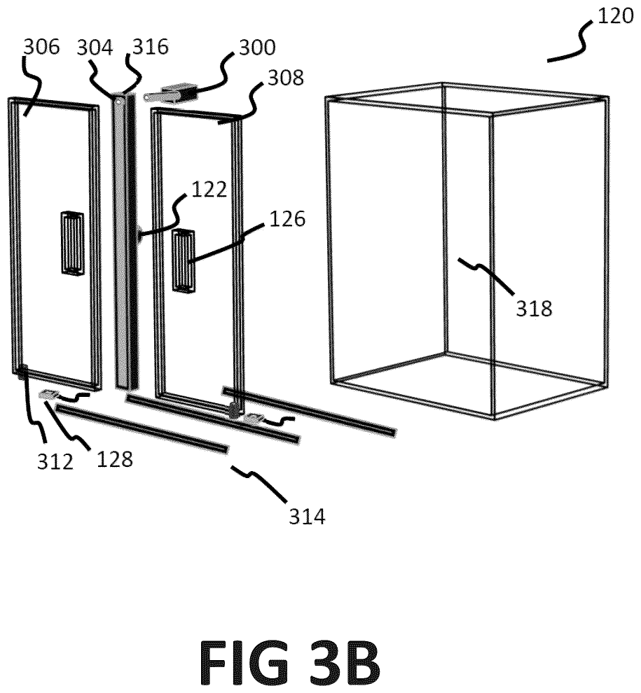

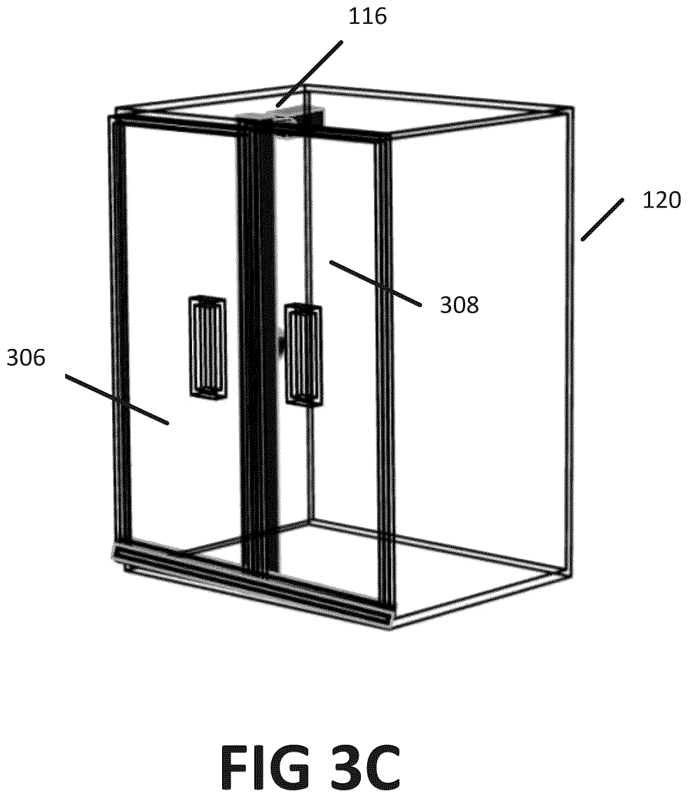

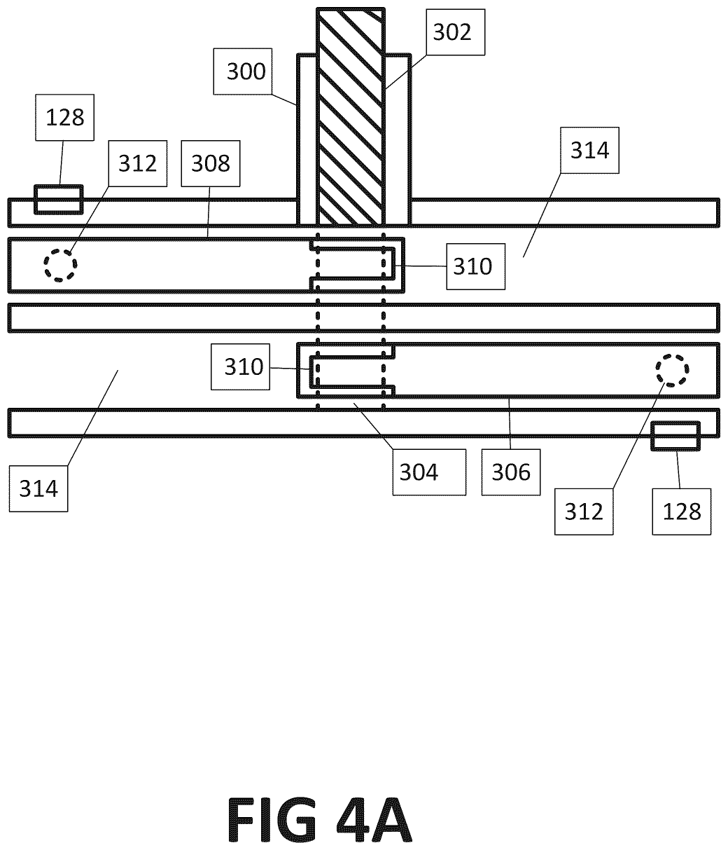

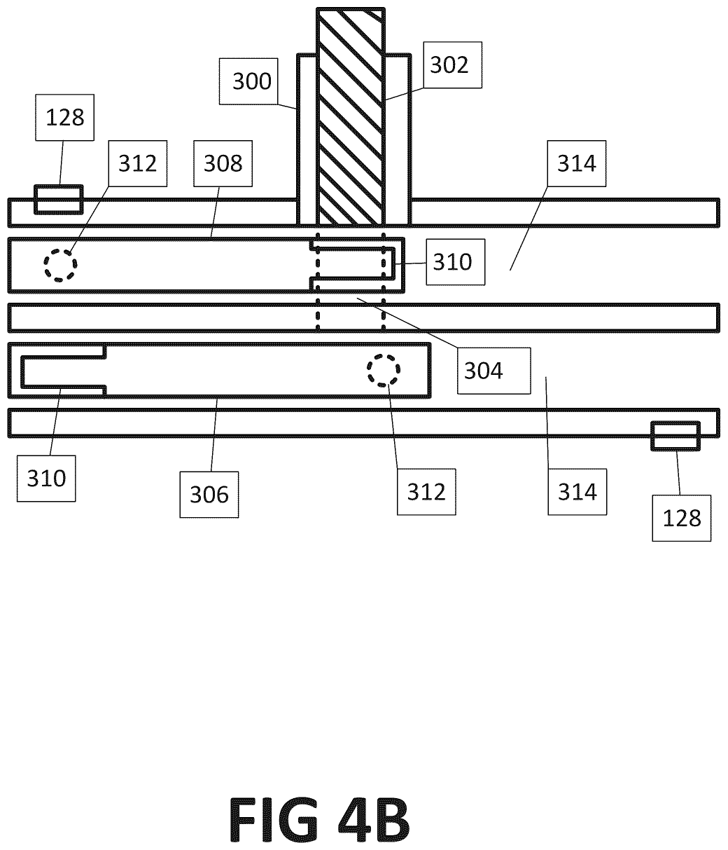

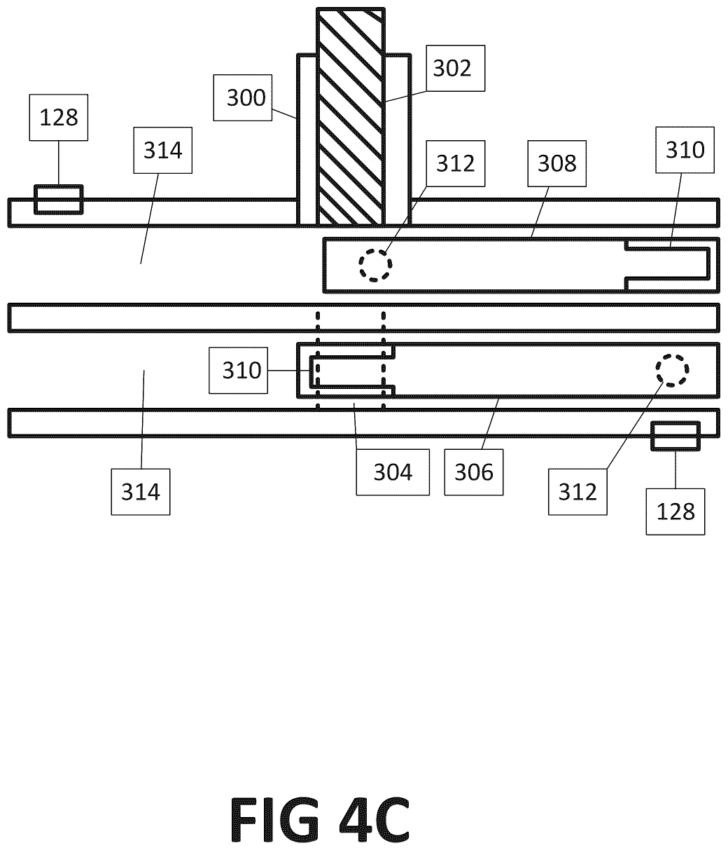

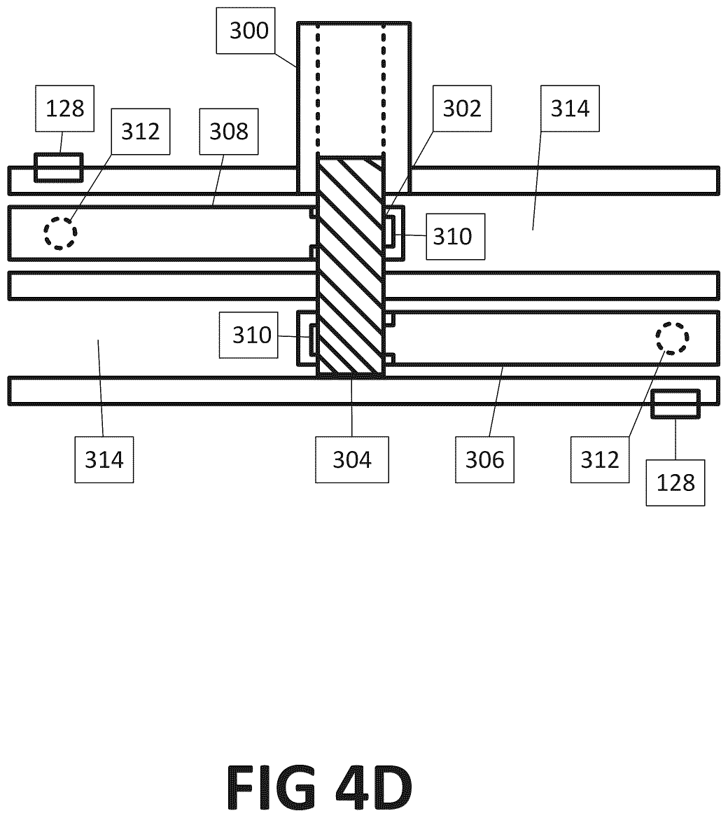

The product display area 116 can include a display security module 120 around the product display module 118. The display security module 120 can be made of plexiglass, glass, or any other appropriate durable, protective, and transparent material. The display security module 120 can further comprise doors used to access the products on the product display module 118. The doors may include locks for restricting access to the products. The doors and locks are discussed in further detail in FIGS. 3A, 3B, and 4A-4D. The display security module may also include a camera 122. Camera 122 can be used both for security and for inventory management, as described in more detail later.

The photo kiosk may further comprise a privacy module 124. The privacy module 124 can be used to separate a user from other customers during creation of photo products. The privacy module 124 can also be used as a customizable background for photos taken at the kiosk, including providing a “green screen” backdrop such that photos taken at the kiosk may superimpose any preloaded background for the photographs. These photos taken against the background can include those used for identification requiring a solid or blank background, selfies, or photos with digitally added backgrounds.

The photo kiosk can be configured to require minimal intervention to manage the kiosk. Intervention can be limited to restocking and rearranging photo merchandise items and maintaining kiosk printers. Photo product assembly can be performed by customers instead of support staff. This can be done through the use of printed assembly instructions with guides, illustrations, templates, color coding, and/or human or machine-readable graphics and text. Other embodiments can include static or dynamic presentations on the touch screen display 104, on the user's mobile device via communication with the kiosk, or separate promotional display. The photo kiosk can also be assembled as a print only kiosk.

Kiosk configuration can be determined by the venue and event requirements. This can include configuration options for the style, color, layout, configuration, and utilities and modules of the kiosk, GUI, language, product selection, trade dress, and ad content.

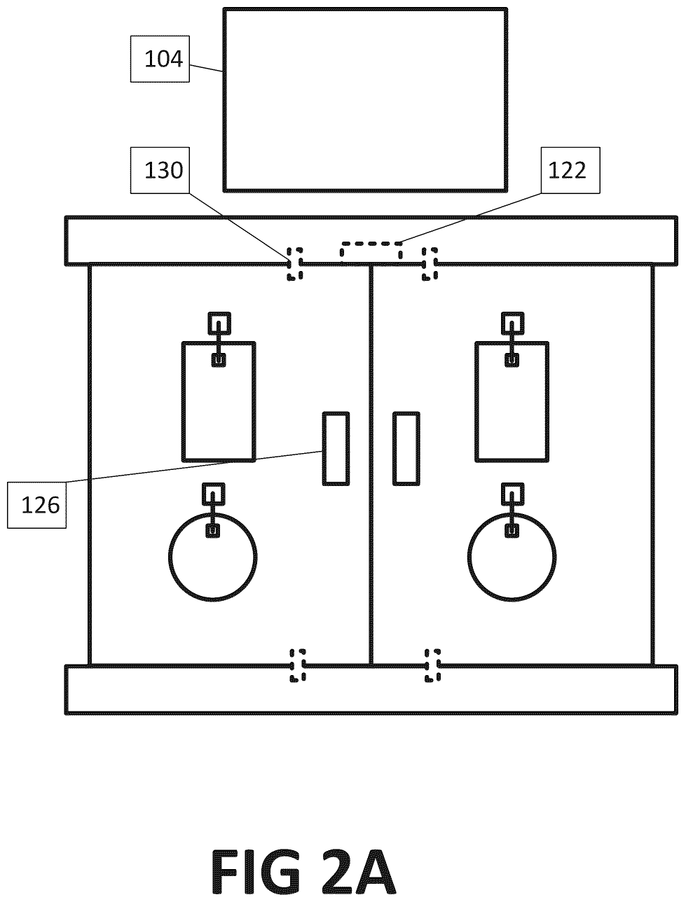

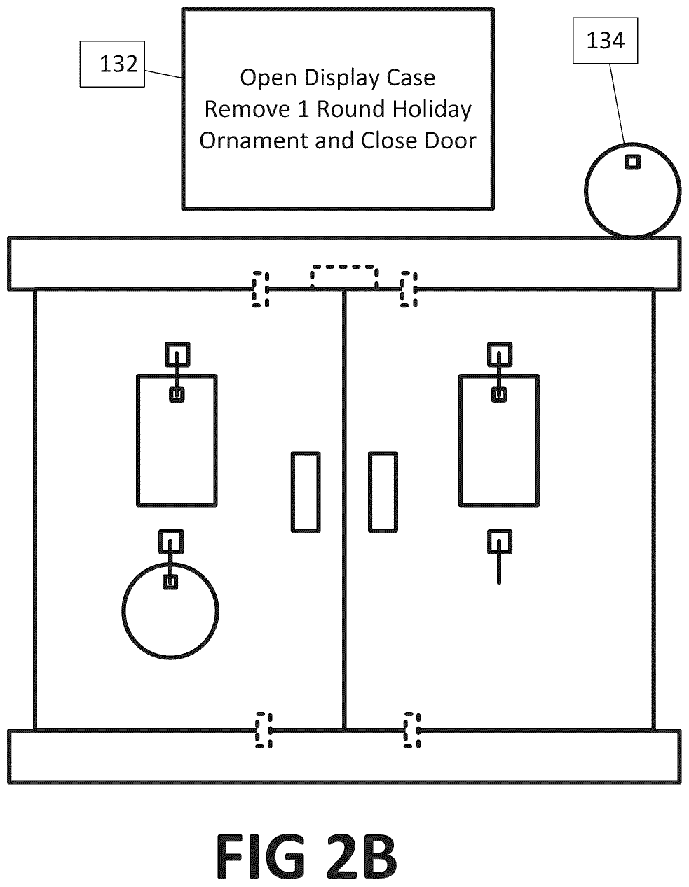

FIGS. 2A and 2B depict an embodiment of the photo kiosk with instructions for retrieving photo products. The photo kiosk can include the touch screen display 104, display security module 120, camera 122, handles 126 positioned to open the display security module 120, door position sensors 128, and locking mechanism 130.

According to one embodiment, when a purchase is made, the touch screen display 104 can display a message 132 with instructions for retrieving the photo merchandise 134 as shown in FIG. 2B. At this time, the locking mechanism 130 may open due to instructions from the processor to allow the user to open the display security module 120 with the handles 126 to access the photo merchandise 134. The locking mechanism 130 may comprise solenoid locks, electronic locks, magnetic locks, mechanical locks, cylindrical locksets, deadbolt locks, or any other suitable securing mechanism. After the photo merchandise 134 is removed, the display security module 120 can be closed with the handles 126. Door position sensors 128 can check the position of the door to ensure it is closed before proceeding with the transaction. After the door position sensors 128 ensure closure of the door, the processor can engage the locking mechanism 130 to lock the display security module 120 shut until the next transactions.

FIG. 3A depicts an embodiment of a sliding door with electronic solenoid lock according to an embodiment of the present technology. The shown embodiment can be used as a display security module for preventing access to the photo merchandise. The doors can include a solenoid lock cylinder 300, a solenoid lock bolt 302, a door lock box 304, first and second doors 306, 308, a door metal trim 310, a door position sensor 128, embedded magnets 312, and sliding door tracks 314. The doors shown in FIG. 3A are in an unlocked and closed position.

As illustrated in FIG. 3A, the doors 306, 308 can sit on individual sliding door tracks 314. In this position, door position sensors 128 can detect the embedded magnets 312 within doors 306, 308 and relay the door position to the processor. From this, the door position sensors 128 can relay a door closed message to the processor to indicate that the doors are in a closed position. When the doors are open, the door position sensors 128 can no longer detect the embedded magnets 312 and relay a door open message to the processor to indicate that the doors are in an open position.

A solenoid lock bolt 302 can be used to secure the two doors to prevent unauthorized access. In a locked position, the solenoid lock bolt 302 can be extended through the door lock box 304 and door metal trim 310 to secure the doors. The bolt 302 can be extended into the door lock box 304 or retracted into the solenoid lock cylinder 300 by any appropriate method to do so. The solenoid lock bolt 302 can be controlled by the processor to manage access to the inventory.

FIG. 3B depicts an embodiment of a display security module 120 comprising the embodiment of the sliding door depicted in FIG. 3A prior to assembly. The display security module 120 can comprise a center post 316. The center post 316 can be used to serve as a locking point for the doors 306, 308 and to support the kiosk. The center post 316 can further comprise camera 122. The display security module 120 can comprise an open side 318 to receive the doors 306, 308 mounted on the sliding door tracks 314.

FIG. 3C depicts an embodiment of an assembled display security module 120 depicted in FIG. 3B. As assembled, the product display area 116 inside of the display security module 120 may only be accessed through the doors 306, 308 which can be secured by the locking mechanism 130.

FIGS. 4A through 4D depict embodiments of the doors 306, 308 (e.g., as shown in FIG. 3A) configured in various positions. FIG. 4A, for example, depicts an embodiment where the doors are in an unlocked and closed position. In this position, the bolt can be retracted by the processor such that the doors are moveable but neither door has been opened at this time. FIG. 4B depicts an embodiment in which the doors are unlocked and configured in a left side opened position. In this embodiment, the bolt has been retracted and the first door 306 has been moved to access the photo products inside. FIG. 4C is similar to the embodiment shown in FIG. 4B in that the doors are depicted unlocked but configured in a right-side open position. FIG. 4D depicts an embodiment where the bolt has been extended into the door lock box to securely lock the doors.

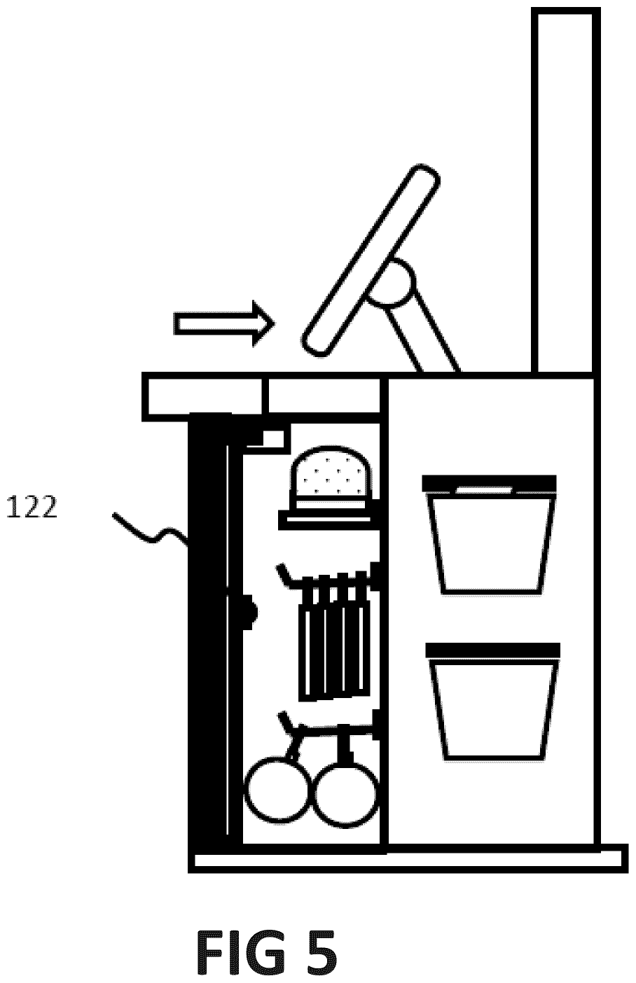

FIG. 5 depicts an embodiment comprising camera 122. Camera 122 can be used with the processor for both inventory control and kiosk security. Camera 122 can be a wide-angle camera to be able to monitor the entire inventory of the kiosk and can be configured with the processor to include an image recognition algorithm to keep track of product inventory. Camera 122 can also be configured to transmit the recording to a remote location through the communication device.

Products can be arranged and displayed to facilitate monitoring by camera 122. Products can include product tags displayed in a direction such that they are visible to camera 122. In one embodiment, for example, the products may have barcodes displayed in a direction such that they are visible to camera 122. In a further embodiment, the products may have color coded packaging for easier identification by camera 122. Products may further be staggered within the kiosk to facilitate viewing and identification by camera 122. Camera 122 and processor can use a counting algorithm to manage the number of products within the kiosk.

As a part of the kiosk security function, camera 122 can record a constant video recording loop of the inventory. Camera 122 and processor can monitor the inventory to keep track of the amount and location of each photo product. The constant video recording can be used to compare inventory counts before and after customer interaction at the processor.

In embodiments where the display security module 120 is not provided, camera 122 can monitor inventory for theft during times of no logged customer interaction. This can be done by analyzing the constant video recording by the processor for human interaction and missing products in instances where a customer is not detected. In this instance, the kiosk may signal a local alarm to notify employees of the theft. The kiosk may also be connected to a store security network. In this configuration, the kiosk may activate a store-based alarm to signal the theft.

In embodiments with and without the display security module 120, camera 122 and processor may be configured for a “Browse Products Mode.” In this configuration, a customer may interact with, view, and remove products without triggering an alarm. This mode can be ended after a certain period time or upon confirmation by the customer. At the end of the “Browse Products Mode,” the constant video recording of the camera and processor can compare before and after images using a counting method to ensure the correct number and type of products are in both sets of images. Missing products can trigger a message at the touch screen display 104 or smart phone to replace any products taken from the kiosk. If this is not done, the kiosk may trigger local and/or store-based alarms related with product theft as above.

Camera 122 and processor may be further configured to monitor product purchases. In such embodiments, the constant video recording can monitor the number and type of products before and after a purchase to ensure the proper type and number of products are taken by the customer. Additionally, the touch screen display 104 or smart phone may instruct the customer to scan products removed from the kiosk to ensure removal of the proper products and amount based on the order. In instances where the removed products do not match the order, the touch screen display 104 or smart phone can display instructions to replace incorrectly taken products. If this is not done, the kiosk may trigger local and store-based alarms related with product theft as above.

As part of inventory management, camera 122 and processor can be used to monitor the inventory of the kiosk. The constant video recording can be used to maintain accurate inventory counts of each type of product. The kiosk can perform different actions when there is a low inventory of an individual product below a threshold. The kiosk may alert an employee to stock more of a certain product. The kiosk may be configured to notify a distributor or kiosk manager of the low inventory with instructions for ordering more of the identified product. The kiosk may be further configured to monitor product consumption rates to determine when and the amount required for reorder based on differences in demographics, location, foot traffic, and seasonal variations. This can include predicting when products will be out of stock based on current product sales for the kiosk.

The kiosk may be further configured to provide different customer notifications based on product inventory. In instances of remote ordering, the kiosk may provide a low stock warning to the customer to encourage ordering before stock is further reduced. If a customer is trying to place an order greater than the present stock, the kiosk can be configured to provide various responses. In one embodiment, the kiosk can instruct the customer to arrive at a later time or date after restocking of the desired product has occurred. In another embodiment, the customer can be directed to a different kiosk (in or out of chain) with the required inventory. In a different embodiment, the customer can be directed to a home delivery option or alternative product.

The kiosk can also be configured to present themed image products depending on the available inventory of the kiosk and customer requirements. This process can be used to reduce the intimidation factor of having to self-select the product by suggesting appropriate image treatments and graphics. In one embodiment, the customer may select an emotional context or event type to assist in product selection. A final product integrating the customer supplied images and treatments may be provided to assist in visualizing the product prior to purchase.

The kiosk can be further configured with a restock mode for restocking products within the kiosk. Machine-readable code affixed to the products can be scanned by an employee during the restocking process to add items to the kiosk inventory. The kiosk may also be configured to receive a “manifest” of all items being restocked.

The kiosk may further be in communication with service staff to support the kiosk. The kiosk can be configured to report inventory status to service staff to support routine restocking of the kiosk. The kiosk may also be configured to report regular and critical maintenance issues such as malfunctions to service staff. The report may include a suggested intervention or remedy which can provide instructions, parts lists, replacement component requirements, devices, printers, and tools/equipment to remedy the situation.

Kiosks can be placed in a communication network with other kiosks and a central facility. The central facility can be a support hub for the kiosk and include backstock for product replenishment, kiosk repair tools and parts, unused kiosk modules, and customer ordering services. Notifications can be sent to devices such as smart phones, pagers, tablets, in-store public address systems, or transaction registers. Kiosks may also be configured to use personal communications specific to operators of the kiosk. Kiosks may further include a customer call or help button to summon support should a problem occur.

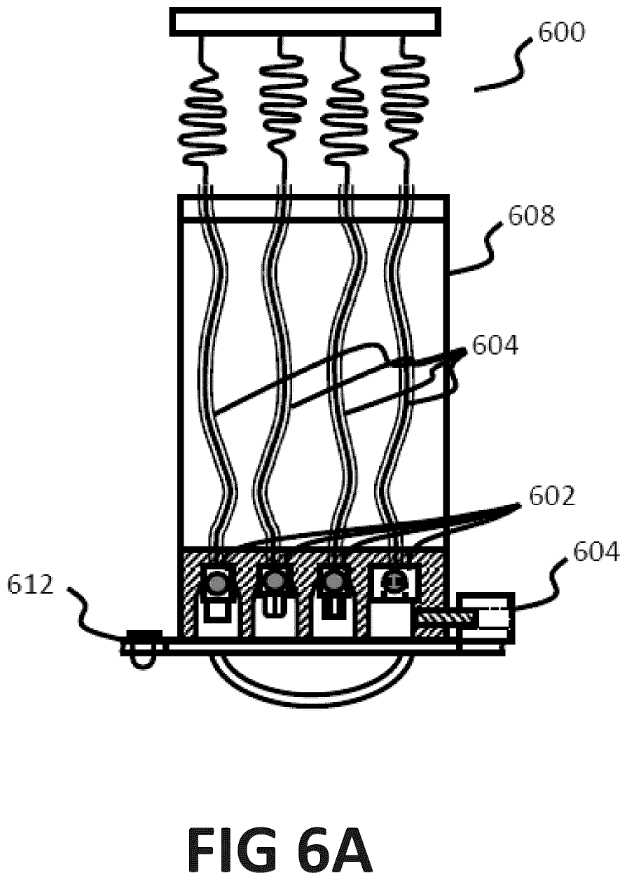

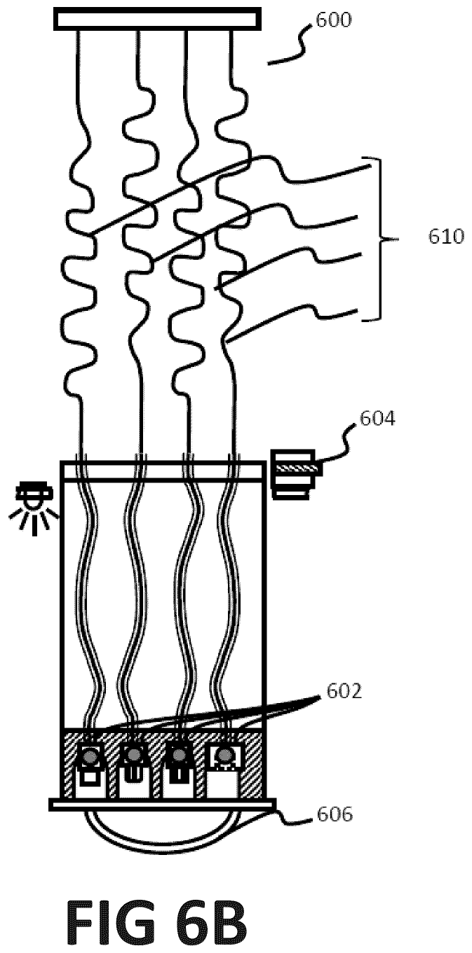

FIGS. 6A-6B depict an embodiment of a connector array drawer 600. During interaction with a kiosk, customers may need various digital data physical connectors for transferring images from a customer device to the kiosk for use in photo products. In unmonitored retail situations, the digital data physical connectors can be subject to tampering, which can result in limited access to the kiosk. Therefore, a connector array drawer 600 can be provided to prevent cable access outside of customer interactions.

The connection array drawer 600 can include various data connectors 602 for connecting to various consumer electronics. The accessible area of the drawer 600 may include reinforced cords to each of the data connectors 602 to prevent tampering and extend life during use. An electronic lock 604 can be provided to secure the drawer 600 when not in use. When a customer requires to upload pictures to the kiosk, the electronic lock 604 can unlock, allowing customer access to the data connectors 602. The customer can use the handle 606 to open the drawer by the connection retainer 608. The data connectors 602 can be drawn out due to the cord slack 610 located behind the connection retainer 608. Once connected, a status indicator 612 can light up to indicate connection of the device for receiving images.

After the images are uploaded, the customer can disconnect the device from the kiosk and close the drawer 600. The kiosk may require that the drawer 600 is properly closed before proceeding onto the next step.

The kiosk may also include the ability to link to apps on a smart phone to select and upload images from different applications. This can allow for image selection and handling through the application storing the photos with options to print to the kiosk.

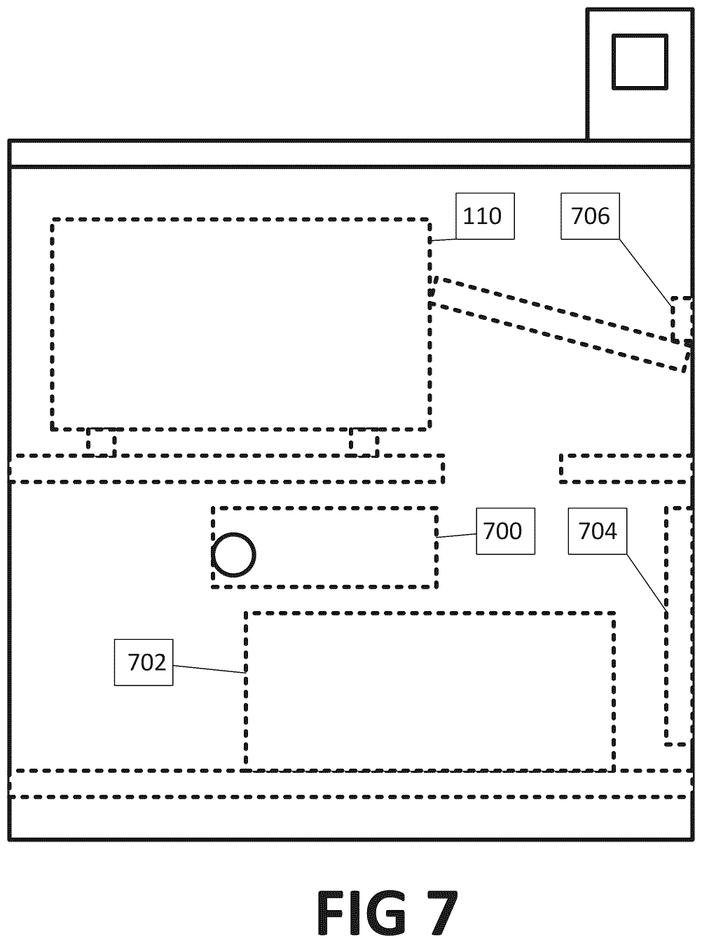

FIG. 7 depicts an embodiment of a kiosk comprising a personal shopper module. According to this embodiment, the kiosk may be integrated with a third-party delivery option to allow remote order placement and delivery from a kiosk. Placed orders can include a username, address, price, phone number, order placement location, and promised delivery date and time in human and machine-readable forms on a separate print. The additional print can be placed at the top of a print stack to cover exposed prints and provide privacy for the first print of the stack.

The kiosk can be provided with a banding packing module 700 in addition to the printer 110 in this configuration. Orders to be picked up by a personal shopper can be printed by the printer 110, and then banded as shown by the banding packing module 700. Prints can be collected by the banding packing module 700 with the print with the order details on the top of the stack of prints. The completed order can then be banded by the banding packing module 700 where they can be dropped into a lower bin 702 for pickup by a personal shopper through lower access door 704. The lower access door 704 can giver personal shoppers access to the lower bin 702 where completed orders are stored until pickup. The personal shopper can receive the order number to ensure the correct print package is selected when picking up. The kiosk may be further configured to package in shrink wrap, envelopes, or rubber or paper bands. The kiosk may also be configured to record a chain of custody from the kiosk to the customer to ensure that customer privacy is maintained and so that the right order goes to the right customer.

The kiosk can also have an upper access door 706 that can be used to deliver “on demand” orders made at the kiosk. Since the user is present at the kiosk at the time of printing, there is no need to store the order in the lower bin 702 and the order can be directedly completed without using the banding packing module 700.

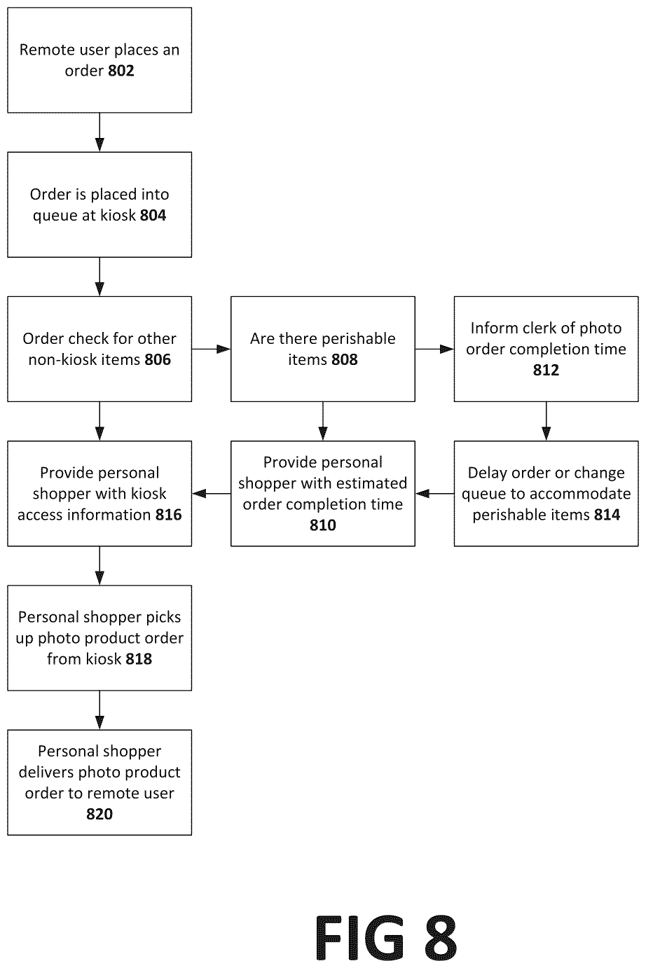

FIG. 8 describes a remote order process with personal shopper. The process begins when a remote user places an order at the kiosk of the present technology in step 802. The order is placed into queue for completion at step 804 and a personal shopper is assigned to the order. In step 806, the order is checked for non-kiosk items. If the order does include non-kiosk items, the method proceeds to step 808 where the order is checked for perishable items. If there are no perishable items, the estimated order completion time is sent to the personal shopper in step 810 to assist the personal shopper in coordinating the pickup with the other items of the order.

If there are perishable items in the order, the kiosk can inform a clerk in step 812 to ensure that the order is complete in time with the perishable items. If there are issues with the timing, the order can be delayed or the order can be moved ahead in the queue in step 814 to accommodate the perishable items.

When the order is ready, the personal shopper can be provided with kiosk access information in step 816. For example, the personal shopper can be given access to the banded photos in the lower bin 702. The personal shopper can then pickup the order from the kiosk in step 818. Finally, the personal shopper can deliver the order to the remote user in step 820, completing the order.

According to another aspect of the present technology, the modular photo kiosk systems described herein may comprise a photo clerk tool for monitoring, maintaining, and operating one or more photo kiosks. The tool can be a software application implemented into a smartphone, tablet, and/or personal computer. The tool can be used by in-store clerks employed by the retailer, route-based managers of the kiosk, and/or independent service providers. The tool can provide a means to communicate with kiosk support staff regardless of employment arrangement.

The tool can be configured with varying levels of access depending on the clerk using the tool. Newer clerks with fewer skills and less experience with the kiosk can support routine maintenance, restock media, restock photo merchandise, remove chad, restock receipt paper, and empty bill collectors. Clerks with higher skill levels and more experience can be provided instructions to diagnose problems, change out failed components, load new software, manage inventory control, and select new Point-of Purchase, Marketing Communications, and promotions.

One embodiment of the tool can provide for proximity control of tool access. The tool can determine its location through the use of geo-location, proximity measurements, geofencing, and/or Wi-Fi source. The tool can be configured to allow kiosk access and to receive notifications when the clerk and tool are on the retail premises. When the clerk and tool are off of the retail premises, the tool can be configured to block notifications and prevent access to the kiosk.

When the clerk is detected to be working, the tool can be further configured to record clerk performance. This can include monitoring the number of actions completed, response time to the actions, number of in-store hours with check in and check out times, and the types of tasks that were completed. This can further be used to track clerk errors related to performing product finishing or kiosk maintenance. Recorded errors can be used to provide clerk training where appropriate and ensure that clerk skill level is adequate to support customer and kiosk requirements.

The tool can further comprise error condition reporting. This can report errors from the kiosk to clerks at the retail location. Exemplary errors can include printer jams, depleted or soon to be depleted media, software issues, failed printers, and failed computers. The tool can include intervention options for errors not able to be corrected by the clerk. This can include phone or online helplines, requesting and scheduling service engineers, documenting the error with photos and/or error codes, and scheduling the exchange of malfunctioned or damaged equipment with replacement equipment. Intervention options can be automatically offered based on multiple-choice interactive question sets.

The tool can further comprise instructions for unretrieved orders. Unretrieved orders can be produced orders that are not paid for or picked up within a time threshold. The time threshold can be automatically adjusted depending on the number of active users or length of queue at the kiosk. The clerk can obtain the order and attempt to contact the customer based on instructions from the tool. This can include providing phone, text, or e-mail reminders to the customer to pick up the order and finish the transaction. This can further include the use of the retail location's public address system to contact the customer if they are still at the retail location.

In the event that the customer cannot be contacted, the tool can be configured to provide instructions to dispose of the order. Due to privacy concerns, the instructions can comprise disposal instructions such that the order cannot be recovered. This can include cross-cut shredding or incineration of the order.

The tool can be further configured to provide shutdown procedures for the associated kiosks. This can be included for retail locations that do not provide 24-hour access and close the store at certain times. The tool can be configured to shutdown the kiosk while not generating error message on the tool. This can further terminate communication between the kiosk and the tool.

The tool can be configured with a countdown clock for monitoring the shutdown of the kiosk. The tool can be configured to override the shutdown timer in the event that orders are still being processed or customers arrive prior to closing that require kiosk access. The kiosk can be configured to communicate to the tool when the shutdown is delayed due to in-process orders. The tool can further be configured to provide a list of devices that require continued power access even when shutdown. This list can include computers for remote start-up and inkjet printers to prevent the print head from drying out.

The tool can be configured with an interactive floor plan of the retail space including the kiosks. The map can be configured to show the layout of equipment including printers, printer arrays, user terminals, master displays, and finishing devices. The map can be further configured to contain text and graphical annotations to show the status of the various devices. Alternatively, the tool can use a navigable panoramic view of a photo department with graphic overlays.

The tool can be further configured to include an augmented reality feature. This can be used to provide text and graphic overlay in real time based on the view of the equipment from the phone or tablet. Augmented reality can be used to guide a clerk in troubleshooting and repairing the kiosk, assembling products, and training for the kiosk.

The tool can be configured to provide upselling reminders to the clerk during interactions with customers. This can include suggestions for additional products based on the current order. The tool can be configured to record when this is successful.

Upselling success can be managed by the tool to further encourage clerk suggestions. The tool can be configured to provide incentives, suggested interventions, tools and real-time training to encourage clerk participation. The tool can be used to rank or rate clerk performance for monetary and/or recognition awards.

The tool can be further configured to provide a chat bot service. This can allow for text-based messaging with technical support, repair scheduling services, order tracking for media and supplies, and order tracking for remotely produced photo product shipments to the retail store. The chat bot can further be integrated with a phone or tablet camera to record different items. These can include shipping labels/manifests, equipment data plates, damage on received orders, and equipment failures.

The chat bot can present various options to the clerk based on the required intervention. The chat bot can further provide guidance to the clerk regarding the required images needed. The chat bot can work autonomously and/or include human operation backup if further assistance is required.

The tool can be further configured to provide a quality check function for the kiosk. This can be implemented by printing test targets at the kiosk. A clerk can then use the tool to photograph and upload the printed test targets. Alternatively, a print scanner can be used to record and upload the printed test targets. The tool can use these uploads to ensure that the kiosk is properly calibrated. If the tool detects that the kiosk is not calibrated, the tool can automatically recalibrate the kiosk.

The tool can also be configured with a clerk check-in function. This can be used to show which clerks are available to other clerks and supervision. This can be used to ensure the retail store and kiosks are properly staffed. The check-in function may contain contact information for the clerk staff. This can be used to contact the clerk staff to inquire about availability for additional clerk staff. Retail store supervisors can use this function to approve additional clerks, change the priority listing for the clerks, and edit the clerk staff. Clerks can also use this function to designate availability and “on call” times.

The tool can be configured with a validation function for kiosk access. In an embodiment, the tool can provide a specialized bar code or QR code on the phone screen using the tool. This can be read by the cameras associated with the kiosk to provide appropriate access. This can be used to provide access to kiosk system setup, configuration, service, and maintenance modes. This can also be used to identify the clerk accessing the kiosk.

The tool can be further configured to communicate and coordinate with personal shoppers associated with the retail store or through a third-party provider. The tool can provide two-way communication between clerks and personal shoppers to ensure that the photo product portion of the order is fully produced.

When the order includes perishable items, the tool can be used to inform the clerk when the photo order must be completed. This can include a countdown clock for when the order must be completed. The tool can evaluate the photo order and current kiosk queue to estimate order completion. The tool can further reorder the queue if the order cannot be completed within the required amount of time initially. If the photo order is delayed or the queue is too long, the tool can communicate with the person shopper an estimated completion time. The personal shopper can then delay the order, change the shopping queue, or store perishable items in an appropriate location while waiting for the photo order.

The tool can be further configured to scan a receipt associated with the personal shopper order. This can be used to notify the personal shopper that the order is ready for pickup. The tool can also alert the clerk when the personal shopper has arrived to pickup the photo order. The tool can also alert the clerk when the customer arrives to pickup the photo order when a remote order is placed without a personal shopper.

The invention claimed is:

1. A method of operating a retail photo kiosk system comprising:
providing a retail photo kiosk with a processor, a communication device, one or more printers, a photo merchandise display unit, a payment mechanism, and user interface for producing photo products incorporating user provided images;
using the processor to provide a plurality of user selectable digital templates that correspond to a plurality of photo merchandise items;
using the user interface to select at least one photo merchandise item;
using the user interface to provide one or more user images to the processor via the communication device;
the processor selects one or more digital templates corresponding to the selected photo merchandise item;
the user selects one or more digital templates for combination with the one or more user provided images;
the processor combines the one or more digital templates and the one or more user provided images and sends the combined one or more digital templates and images to the printer;
the printer produces at least one print of the combined template and image;
the user interface instructs the user to retrieve the combined template and image print and the corresponding photo merchandise item from the kiosk;
the processor calculates the total fee for the retrieved items;
and the user interface instructs the user to pay the calculated fee via the payment mechanism.

2. The method of claim 1, wherein the communication device provides a wired connection, wireless cellular connection, or WIFI modem and the user interface is accessible via a touch screen display associated with the photo kiosk and/or the user's personal phone, tablet, and/or computer.

3. The method of claim 2 further comprising:
accessing the photo kiosk locally within the retail venue and/or remotely.

4. The method of claim 1, wherein the at least one print is produced once the calculated fee is received via the payment mechanism.

5. The method of claim 1, wherein the as least one photo merchandise item is presented on interchangeable hooks, transparent shelves, or bins in the display unit of the photo kiosk.

6. The method of claim 5, wherein the as least one photo merchandise item is visible in the display unit but inaccessible until the calculated fee has been received via the payment mechanism.

7. The method of claim 5, wherein the processor maintains an inventory of photo merchandise items.

8. The method of claim 6, wherein the photo merchandise display unit comprises at least one photo merchandise item and a transparent encasement with an electronic locking mechanism controlled by the processor.

9. The method of claim 6, wherein the at least one photo merchandise item is stored in a transparent encasement with an electronic vending mechanism controlled by the processor.

10. The method of claim 8, wherein the processor instructs the user via the user interface when to open and close the doors photo merchandise unit and verifies the door position and lock status after the photo merchandise item has been retrieved.

11. The method of claim 1, wherein a camera controlled by the processor is used to monitor the at least one photo merchandize item stored and presented in the display unit of the photo kiosk.

12. The method of claim 11, wherein the processor uses the camera and a counting algorithm to maintain an inventory of photo merchandise items.

13. The method of claim 11, further comprising:
mounting the camera within the photo merchandise display unit and providing a wide-angle view of the inventory of display photo merchandise.

14. The method of claim 11, further comprising:
transmitting the view provided by the camera to a remote location via the processor and communication device.

15. The method of claim 11, further comprising:
using the processor to inform the user or operator, via the user interface and communication device, if a photo merchandise item has been removed without the payment.

16. The method of claim 11, further comprising:
using the processor to inform the user or operator, via the communication device and user interface, if the inventory of one or more photo merchandise items presented and stored in the display unit has reached a predetermined threshold and/or is out of stock.

17. The method of claim 12, wherein the processor determines that a user selected photo merchandise item is either out of stock or if an insufficient number of photo merchandise items are in inventory to satisfy the user's selection, using the user interface and communication device to suggest to the user an alternative photo merchandise item, an alternative retail location, or home delivery of the photo merchandise item.

18. The method of claim 12, further comprising:
using the processor to calculate and estimate when at least one photo merchandise item will be out of stock based on previous usage patterns.

19. The method of claim 1, wherein the processor maintains an inventory of print media loaded in the one or more printers and informs the operator, via the communication device and user interface, if the amount of media remaining in the one or more printers reaches a predetermined threshold.

20. The method of claim 19, wherein the processor calculates and estimates when the print media will be exhausted based on previous usage patterns.

21. The method of claim 1, wherein access to the photo kiosk, the user interface, and available photo products is provided via an application, internet browser, internet address, and/or direct wired or wireless connection.

22. The method of claim 1, wherein the payment mechanism includes a Near Field Communication (NFC) device, card reader, and/or currency acceptor.

23. A tool for managing photo kiosk systems comprising:
a proximity control system identifying a location of a retail clerk by geo-location, proximity, geofencing, or Wi-Fi and controls access to the photo kiosk systems, notifications generated by the tool, and monitors staffing of the photo kiosk system including working, available, and unavailable retail clerks;
an error condition reporting system identifying an error of the photo kiosk system, recording an identity of the retail clerk responding to the error condition, providing intervention instructions by an interactive multiple-choice question set, and intervention escalation comprising contacting helplines, scheduling a service engineer, documenting conditions of the photo kiosk system, and exchanging malfunction or damaged equipment;
an unretrieved order monitoring system identifying orders that have not been picked up within a threshold time limit where the threshold time limit varies depending on a number of active users, instructing the retail clerk to contact the customer by a customer's contact information or by a public address system or to destroy the unretrieved order;
a shutdown system providing the retail clerk with instructions on how and when to shutdown the photo kiosk system, a countdown timer for shutting down the photo kiosk where the countdown timer is based on retail hours and in-process orders;
an interactive floor plan map providing a map of the retail space with a layout of photo equipment comprising printers, printer arrays, user terminals, master displays, and finishing devices and graphical annotations indicating a status of the photo equipment;
an event documentation system recording occurrences and images of failure conditions in the photo equipment;
an augmented reality system providing guidance to the retail clerk in training on, repairing, and troubleshooting the photo equipment
an upsell reminder and tracking system providing suggestions to the retail clerk for other products the customer can purchase, incentives for successful occurrences including recognition or monetary awards, and tools and training to improve upsell performance and efficiency;
an autonomous or human operator backed chat box providing text and photo messaging to technical support, repair scheduling, media and supply ordering, and remotely produced product tracking;
a quality check function verifying proper calibration of the photo equipment by uploading test target prints and recalibrating the photo equipment if not properly calibrated;
a validation system providing bar or QR codes for accessing the photo kiosk system identifying the retail clerk accessing the photo kiosk system and placing the photo kiosk system into a setup, configuration, service, or maintenance mode; and
a personal shopper coordination system providing two way communication with an in-house or third-party personal shopper, providing a countdown to the retail with an estimated time to complete the photo order, reordering a queue of the photo kiosk system to accommodate perishable goods of a personal shopper order, notifying the personal shopper of long queue times or delays for the photo order; and notifying the retail clerk when a customer or personal shopper has arrived to the retail location to deliver the photo order.
